(19) United States
(12) Patent Application Publication
(10) Pub. No.: US 2015/0329138 A1
(43) Pub. Date: Nov. 19, 2015

(54) BALL SCREW DRIVE AND POWER STEERING SYSTEM HAVING A BALL SCREW DRIVE

(71) Applicant: THYSSENKRUPP PRESTA AG, Eschen (LI)

(72) Inventor: Klaus PETERREINS, Filderstadt (DE)

(73) Assignee: THYSSENKRUPP PRESTA AG, Eschen (LI)

(21) Appl. No.: 14/432,754

(22) PCT Filed: Sep. 17, 2013
(86) PCT No.: PCT/EP2013/002797

§ 371 Date: Apr. 1, 2015

(30) Foreign Application Priority Data
Oct. 1, 2012 (DE) 10 2012 019 227.4

(51) Int. Cl. B62D 3/08; F16H 25/22

(52) U.S. Cl. CPC B62D 3/08; F16H 25/2204

(57) ABSTRACT

The present disclosure invention relates to a ball screw drive (10) with a threaded spindle (12) and a ball nut (11) which is arranged on it, the threaded spindle (12) being guided via balls (15) in the ball nut (11), and an internal thread (13) of the ball nut (11) at least partially having a spherically configured contour. Furthermore, the present disclosure invention relates to a power steering system which has a ball screw drive (10) of this type.

The present invention relates to a ball screw drive according to the precharacterizing clause of independent claim 1 and to a power steering system according to the precharacterizing clause of independent claim 5.

Document DE 10 2009 019 227 A1 discloses a guide bushing which has an adapted contour, in order to provide more supporting area for the rack in the case of flexural loads, with the result that a plastic deformation of the rack is counteracted. Here, the rack is supported in the outer region; the internal thread of the ball screw drive is not affected by this.

Document GB 952 782 A discloses a screw thread drive for aircraft construction. Here, the nut is designed in such a way that it can bear against the spindle in different ways. The envelope of the intermediate space between the thread turns of the nut is shaped spherically. As a result, the mean flank angle of the thread turns which engage effectively into one another varies. The advantage of an embodiment of this type lies in the fact that the abrasion of the thread takes place more uniformly and that the lubricant which is employed is utilized more effectively.

Special requirements are made of a ball screw drive if it is used in a steering device of a motor vehicle. A steering device of this type usually comprises a steering housing, in which a rack which is connected to a steering column is mounted axially displaceably in order to deflect vehicle wheels. Via the displacement of the rack, a steering angle is changed in a known way, which means that the rack is coupled via corresponding transverse links or track rods and similar mechanical connections to the wheels to be steered.

The ball screw drive is provided to assist the driver during steering, which ball screw drive comprises a threaded spindle which is coupled to the rack, that is to say is incorporated into a longitudinally movable mechanical section. The threaded spindle is likewise moved during the movement of the rack. A positionally fixed ball nut runs in a known way on the threaded spindle. The ball nut can be driven, for example, via a drive motor by means of a belt. The steering movement which is initiated by the driver is assisted via the said motor, after the nut is turned actively and as a consequence the threaded spindle and, with it, the rack are moved. A steering device of this type is also called an electric or electrically driven power steering system with a rack-and-pinion drive (EPAS=electric power assisted steering).

During operation, the ball screw drive is usually exposed to mechanical loads which can be caused firstly as a result of the construction by the belt connection to the drive motor and secondly as a result of an input of force by the track rods. The input of force in the axial direction to the threaded spindle causes flexural loadings of the threaded spindle, as a result of which the spindle is bent. As a result of the bending of the threaded spindle, the ball screw drive or the balls in turn experiences/experience higher loading and therefore increased wear. The belt tension between the motor and a belt pulley can likewise exert a force on the threaded spindle, which force leads to tilting/crossing of the ball nut and therefore increased wear in the ball screw drive.

It is therefore an object of the present invention to develop the ball screw drive mentioned at the outset, in which no wear which is increased in this way occurs despite an external input of force.

A ball screw drive for achieving the object of the invention has the features according to independent claim 1. According to the said claim, a ball screw drive, in particular for a power steering system, is proposed, having a substantially cylindrically configured threaded spindle with an external thread, and a ball nut which has an at least partially cylindrical internal thread in a receptacle and is guided via a number of balls on the threaded spindle, the threaded spindle being arranged concentrically in the receptacle, and the internal thread having a spherically configured contour in an end region. As a result of the enlargement of the receptacle in the end region of the internal thread, the said receptacle can bear over an entire receiving region in the case of elastic bending of the spindle. The play which otherwise usually occurs in the end region can therefore be avoided in the direction of the bending, as a result of which the wear, for example of the balls, can also be reduced.

It can be provided according to one preferred embodiment that the at least one end region has a contour which corresponds substantially to a contour of a threaded spindle, which contour is deformed by way of a flexural load. This results in two corresponding surfaces, as a result of which, in particular, more balls are in radial engagement with the two threads. As a result, a load-bearing capacity of the ball screw drive can also be increased.

According to another advantageous refinement of the invention, the respective end regions of the ball nut, in particular the respective outer thread turns, can be arranged at a greater spacing from the threaded spindle. If a diameter in the end region of the internal thread is somewhat larger than the remaining nominal diameter of the otherwise cylindrically configured internal thread, the spindle which is loaded by the flexural load can be adapted in an improved manner to the contour of the receptacle as a result. This adaptation of the contours brings about an improved distribution of force over a longitudinal extent in the ball screw drive.

Furthermore, it can advantageously be provided that the internal thread has a contour of curved, concave, spherical or conical configuration or the like in a longitudinal extent, one or more thread turns preferably being at a different spacing from the threaded spindle. The end region is configured in such a way that, in the case of a threaded spindle which is bent elastically as a result of axial loading, the bent contour corresponds substantially to the contour of the end region, for which reason the balls are loaded uniformly.

A power steering system for achieving the object according to the invention has the features of independent claim 5. According to the said claim, a power steering system, in particular for a motor vehicle, is proposed, having a ball screw drive with a threaded spindle and a ball nut which is arranged on it, the threaded spindle with an external thread being arranged concentrically in a receptacle of the ball nut with an internal thread, and the threaded spindle and the ball nut being movable relative to one another, the internal thread at least partially having a spherically configured contour. As a result of the spherical contour, the spindle which is deformed under a flexural load can be adapted in an improved manner to the internal thread, in particular in an end region of the said internal thread, which results in more uniform distribution of a radial load to the balls which are arranged between the spindle and the ball nut.

Further advantageous refinements of the invention are described in the subclaims.

In the following text, one preferred exemplary embodiment will be explained in greater detail using the drawing, in which:

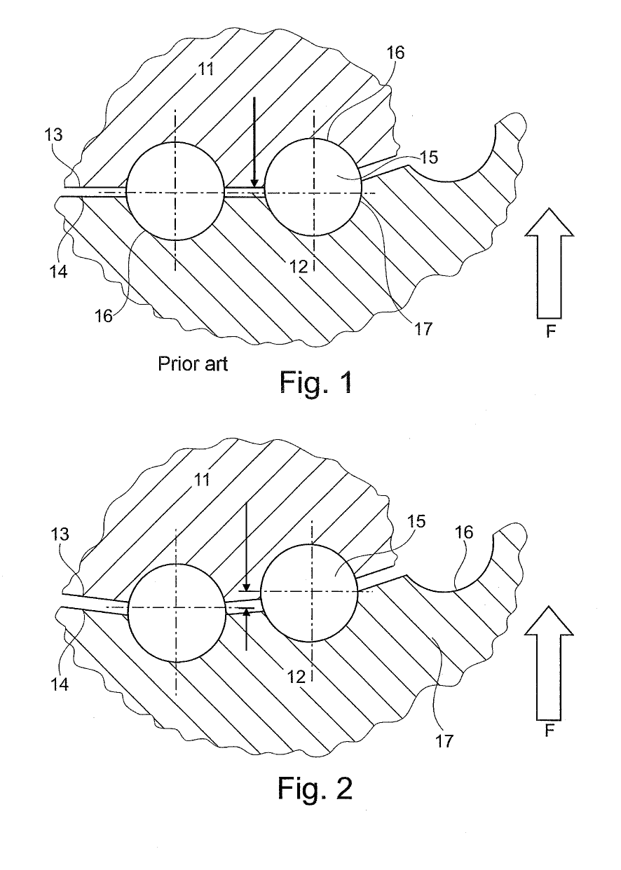

FIG. 1 shows a detail of a cross-sectional view of a conventional ball screw drive,

FIG. 2 shows a detail of a cross-sectional view of a ball screw drive according to the invention,

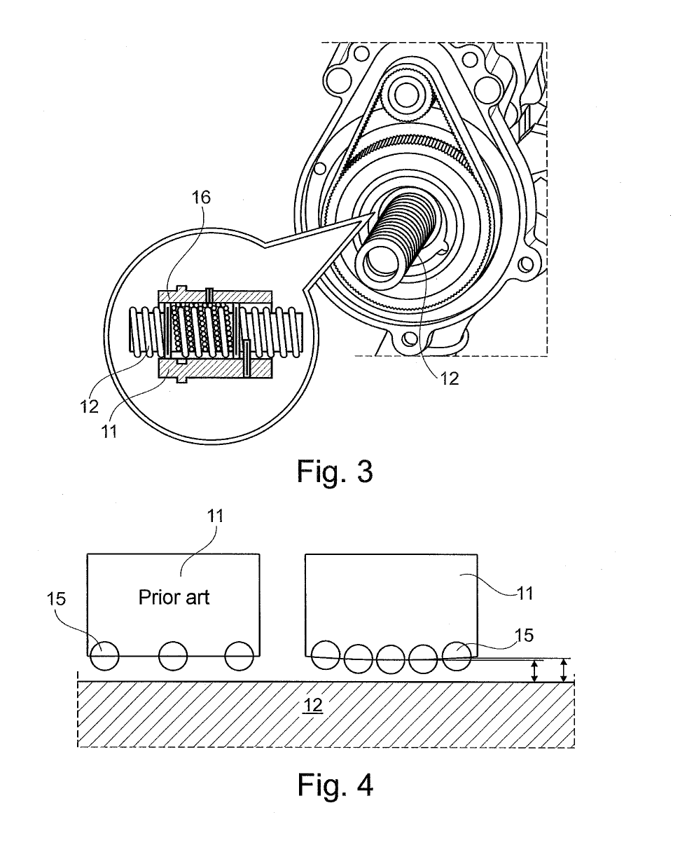

FIG. 3 shows a view of an end region of a ball nut in a ball screw drive, and

FIG. 4 shows an exemplary comparison between the contour of the prior art and the contour according to the invention between the ball nut and the threaded spindle.

A ball screw drive 10 has at least one ball nut 11 and a threaded spindle 12, the ball nut 11 being arranged on the threaded spindle 12 and the two components being movable relative to one another. The ball nut 11 has an internal thread 13 and the threaded spindle has an external thread 14, the two threads 13, 14 corresponding with one another and balls 15 being arranged in respective thread turns 16. The ball screw drive 10 is connected via a belt to an electric servomotor which, for example, sets the ball nut 11 in a rotational movement. Since the ball nut 11 is arranged in a positionally stable manner in the ball screw drive 10, the threaded spindle 12 is moved in an axial direction as a result of the rotational movement of the ball nut 11; in the left-hand or right-hand direction depending on the rotational direction.

The ball screw drive 10 which is shown is preferably part of a steering device of a motor vehicle, the ball screw drive 10 being arranged in a steering force assistance apparatus. Here, the threaded spindle 12 of the ball screw drive 10 is connected directly or indirectly at respective ends to track rods which ensure a steering movement of wheels of the vehicle. As a result of the axial movement of the spindle 12, the track rods are also set in an axial movement, as a result of which the wheels can steer the vehicle to the left or to the right. As an alternative, the spindle 12 can also be positioned fixedly and the ball nut 11 can be moved in a transverse direction of the vehicle, the ball nut 11 being connected directly or indirectly to the track rods in this alternative.

The internal thread 13 of the ball nut 11 is positioned in a receptacle, in which the substantially cylindrically configured threaded spindle 12 is arranged. The internal thread 13 or the receptacle is of substantially cylindrical configuration, for which reason the cylindrical threaded spindle 12 is arranged concentrically in the receptacle. A thread pitch of the internal thread 13 corresponds with a thread pitch of the external thread 14 of the threaded spindle, for which reason the balls 15 which are arranged in each case partially in the thread turns 16 of the internal and external thread 13, 14 run substantially without play in the thread turns 16. Here, a force which is input into the threaded spindle 12 as a result of the rotational movement of the ball nut 11 is transmitted via the balls 15 and in the process produces the translational movement of the threaded spindle 12.

In an end region 17 on both sides of the ball nut 11, the receptacle is not of cylindrical configuration, but rather has a greater diameter of the internal thread 13 in comparison with the cylindrical part of the receptacle. The two end regions 17 namely have a spherically shaped contour. The contour of the end regions 17 can likewise also be shaped concavely, conically or in a generally curved manner As a result of the spherical contour of the end regions 17, a revolution of the thread turn 16 also at least partially has a greater nominal diameter than the revolutions of the thread turn 16 in the cylindrically configured region. A plurality of revolutions can also have a greater nominal diameter, the nominal diameter becoming greater here toward a respective outer end of the internal thread 13. This is shown in FIG. 2.

The spherical contour of the end region 17 corresponds substantially to a bending deformation of the threaded spindle 12 which occurs when axial forces via the track rods which can occur during the operation of the vehicle are transmitted to the threaded spindle 12. The said axial forces generate a bending moment in the threaded spindle 12, as a result of which the latter bends preferably elastically. In the case of an entirely cylindrically configured ball nut 11, the balls would thus be subjected to different radial loading over the length of the internal thread; precisely the balls 15 which are situated in the outer revolutions of the thread turn 16 would be loaded radially to a greater extent. As a result of the spherical contour of the end region 17, the balls are now loaded uniformly despite bending of the threaded spindle 12, as a result of which a bearing fraction is distributed uniformly. The bearing fraction of the balls which are situated in the edge region 17 is reduced as a result.

The end regions 17 of larger diameter with a spherically configured contour can also counteract tilting/crossing of the ball nut 11. As a result of a belt tension between a belt pulley, which is usually connected to the ball nut 11, and the electric motor, the ball nut 11 is regularly subjected to a radial force of such a magnitude that it tilts with respect to the longitudinal axis, for which reason a uniform distribution of the bearing forces of the individual balls is achieved by way of the shaping according to the invention of the end regions.

It is provided, as can be gathered from FIG. 4, that the nominal diameter is at a mean spacing hl from the spindle, the said spacing increasing towards the end regions, for which reason a spacing in the end region is h1+x. The spacing is determined, for example, by a respective middle of the corresponding thread turn 16, for which reason the x can be variable if the spherical shaping of the end region 17 is so great that more than one revolution of the thread turn 16 has a different spacing than the mean spacing h1.

The end regions 17 on both sides of the ball nut can be dimensioned in such a way that the internal thread 13 in the receptacle has a spherical contour over its entire longitudinal extent, a radial centre being an axis of symmetry and being at the spacing h1 from the threaded spindle 12. Accordingly, the remaining revolutions of the thread turn 16 have a spacing h1+x which increases in the direction of the respectively outer ends. In this embodiment, the internal thread 13 has a concave contour.

The invention is distinguished by a ball screw drive 10 having a threaded spindle 12 and a ball nut 11 which is arranged on it, the threaded spindle 12 being guided via balls 15 in the ball nut 11, and an internal thread 13 of the ball nut 11 at least partially having a spherically configured contour. Furthermore, the invention relates to a power steering system which has a ball screw drive 10 of this type.

1.-5. (canceled)

6. A ball screw drive for a power steering system, comprising:
a ball nut defining an internal receptacle and having an at least partially cylindrical internal thread defined in said receptacle, said internal thread having a spherical contour defined in at least one end region;
a substantially cylindrical threaded spindle concentrically disposed within said receptacle of said ball nut, and having an external thread defined thereon; and
a plurality of balls disposed between said internal thread in said receptacle of said ball nut and said external thread of said spindle, and configured to guide said ball nut on said threaded spindle.

7. The ball screw drive of claim 1, wherein said at least one end region has a contour which corresponds substantially to a contour of said threaded spindle, which contour is configured to be deformed by way of a flexural load.

8. The ball screw of claim 1, wherein respective end regions of said ball nut adjacent respective outer thread turns of said ball nut are disposed at a greater spacing from said threaded spindle than thread turns of a middle region of said ball nut.

9. The ball screw of claim 1, wherein said internal thread has a contour of at least one of a curved, concave, spherical or conical configuration in a longitudinal extent, wherein one or more thread turns is disposed a different spacing from the threaded spindle.

10. A power steering system for a motor vehicle, comprising:
a threaded spindle with an external thread defined thereon; and
a ball nut defining an internal receptacle and having an at least partially spherical contoured internal thread defined in said receptacle, said ball nut being concentrically coupled to said ball screw about said external thread, and said ball nut and said threaded spindle being movable relative to one another,
wherein said coupled ball nut and threaded spindle are configured as a ball screw drive.
